(19) United States
(12) Patent Application Publication
(10) Pub. No.: US 2016/0246686 A1
(43) Pub. Date: Aug. 25, 2016

(54) CONTROL APPARATUS, CONTROL METHOD AND RECORDING MEDIUM STORING CONTROL PROGRAM

(71) Applicant: NEC Corporation, Tokyo (JP)

(72) Inventor: Kouki SAKATA, Tokyo (JP)

(73) Assignee: NEC Corporation

(21) Appl. No.: 15/019,024

(22) Filed: Feb. 9, 2016

(30) Foreign Application Priority Data
Feb. 24, 2015 (JP) 2015-034291

(51) Int. Cl. G06F 11/14

(52) U.S. Cl. CPC G06F 11/1469; G06F 11/1435; G06F 11/1451; G06F 2201/84

(57) ABSTRACT

A control apparatus according to an exemplary aspect of the present invention includes: circuitry configured to: receive a notification including information about an error in backing up to a first storage apparatus; perform failure analysis to detect an error in the backing up on a basis of the notification, and determine whether or not the error is caused by failure of the first storage apparatus; and instruct, when the error is caused by the failure of the first storage apparatus, an information processing apparatus performing the backing up to perform backing up to a second storage apparatus capable of communicating with the information processing apparatus to the second storage apparatus.

This application is based upon and claims the benefit of priority from Japanese Patent Application No. 2015-034291, filed on Feb. 24, 2015, the disclosure of which is incorporated herein in its entirety by reference.

### TECHNICAL FIELD

The present invention relates to a technology of controlling backing up data by an information processing apparatus.

### BACKGROUND ART

Data may be lost when an information processing apparatus fails to back up the data. An impact of loss of data may become very large. Backing up fails because of, for example, failure of hardware required for the backing up. For example, Japanese Patent Application Publication No. 2002-297456 (hereinafter referred to as PTL 1) discloses an example of a technology of avoiding failing to back up data by the information processing apparatus.

When reserving a plurality of systems of resources and paths required for backing up data, a backup execution system described in PTL 1 performs backing up by using the reserved resources and paths.

### SUMMARY

One of objects of the present invention is to provide a control apparatus and the like capable of avoiding failing to back up while reducing the cost.

A control apparatus according to an exemplary aspect of the present invention includes: circuitry configured to: receive a notification including information about an error in backing up to a first storage apparatus; perform failure analysis to detect an error in the backing up on a basis of the notification, and determine whether or not the error is caused by failure of the first storage apparatus; and instruct, when the error is caused by the failure of the first storage apparatus, an information processing apparatus performing the backing up to perform backing up to a second storage apparatus capable of communicating with the information processing apparatus to the second storage apparatus.

A control method according to an exemplary aspect of the present invention includes: receiving a notification including information about an error in backing up to a first storage apparatus; performing failure analysis to detect an error in the backing up on a basis of the notification, and determining whether or not the error is caused by failure of the first storage apparatus; and instructing, when the error is caused by the failure of the first storage apparatus, an information processing apparatus performing the backing up to perform backing up to a second storage apparatus capable of communicating with the information processing apparatus.

A non-transitory computer readable storage medium according to an exemplary aspect of the present invention stores a control program causing a computer to execute processing of: receiving, from an information processing apparatus performing backing up to a first storage apparatus, a notification including information about an error in the backing up; performing failure analysis to detect an error in the backing up on a basis of the notification, and determining whether or not the error is caused by failure of the first storage apparatus; and instructing, when the error is caused by the failure of the first storage apparatus, an information processing apparatus performing the backing up to perform backing up to a second storage apparatus capable of communicating with the information processing apparatus.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of a control system according to a first exemplary embodiment of the present invention;

FIG. 2 is a figure schematically illustrating an entire image of a control system according to the first exemplary embodiment of the present invention;

FIG. 3 is a figure schematically illustrating an example of an information table;

FIG. 4 is a flow chart illustrating an example of an operation of a control system according to the first exemplary embodiment of the present invention;

FIG. 5 is a flow chart illustrating an example of an operation during registration of an information table of the control system according to the present exemplary embodiment;

FIG. 6 is a block diagram illustrating an example of a configuration of a control apparatus according to a second exemplary embodiment of the present invention;

FIG. 7 is a block diagram illustrating an example of a hardware configuration of a computer capable of achieving the control apparatus according to the exemplary embodiments of the present invention;

FIG. 8 is a block diagram illustrating an example of a hardware configuration of a control apparatus according to the first exemplary embodiment of the present invention achieved with a dedicated circuit;

FIG. 9 is a block diagram illustrating an example of a hardware configuration of a control apparatus according to the second exemplary embodiment of the present invention achieved with a dedicated circuit; and

FIG. 10 is a flowchart illustrating an example of an operation of the control apparatus according to the second exemplary embodiment of the present invention.

### EXEMPLARY EMBODIMENT

Subsequently, an exemplary embodiment of the present invention will be explained in detail with reference to drawings.

### First Exemplary Embodiment

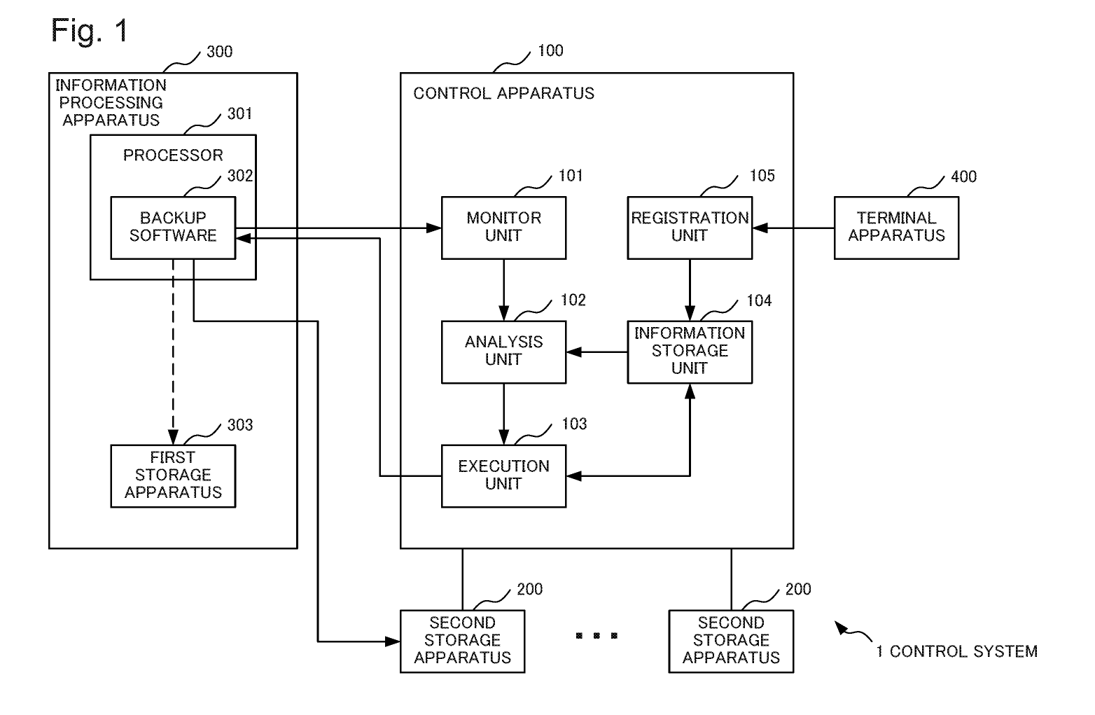

FIG. 1 is a block diagram illustrating an example of a configuration of a control system according a first exemplary embodiment of the present invention.

As shown in FIG. 1, a control system 1 according to the present exemplary embodiment includes a control apparatus 100 and a second storage apparatus 200. The control system 1 may include two or more second storage apparatuses 200. The control system 1 may further include a terminal apparatus 400. The control apparatus 100 and the terminal apparatus 400 are communicably connected with each other. The control apparatus 100 may also be communicably connected with the second storage apparatus 200.

The control apparatus 100 is further communicably connected to the information processing apparatus 300. The information processing apparatus 300 is also communicably connected to the second storage apparatus 200. In the example of FIG. 1, the information processing apparatus 300 is connected with the second storage apparatus 200 via a path not passing through the control apparatus 100. However, the information processing apparatus 300 may be connected with the second storage apparatus 200 via the control apparatus 100.

The control apparatus 100 includes a monitor unit 101, an analysis unit 102, an execution unit 103, an information storage unit 104, and a registration unit 105.

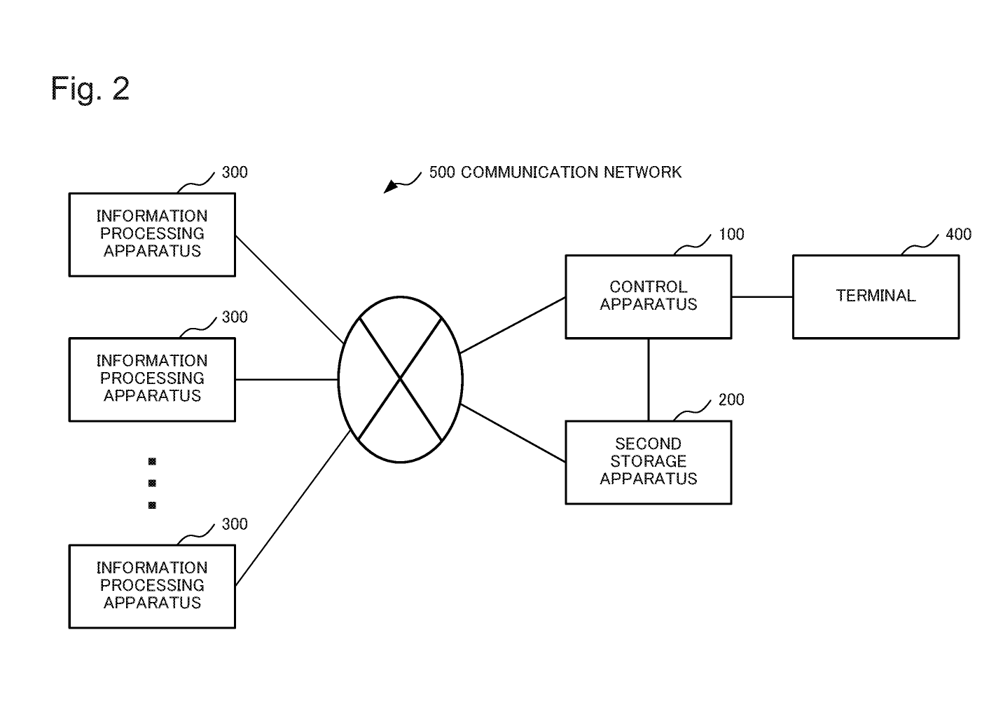

FIG. 2 is a figure schematically illustrating an entire image of the control system 1 according to the present exemplary embodiment. As shown in FIG. 2, a plurality of information processing apparatuses 300 are connected via the communication network 500 with the control apparatus 100 and the second storage apparatus 200. As shown in the example of FIG. 2, a plurality of information processing apparatuses 300 may be connected with the control apparatus 100. In the following explanation, the control system 1 includes one information processing apparatus 300.

The information processing apparatus 300 includes a processor 301 and a first storage apparatus 303. The processor 301 executes the backup software 302. The first storage apparatus 303 may be included in a housing of the information processing apparatus 300. The first storage apparatus 303 may be provided outside of the housing of the information processing apparatus 300, and may be connected with the information processing apparatus 300.

The processor 301 performs backing up by executing the backup software 302. This backing up is processing in which, for example, data stored in a storage apparatus (not shown) included in the information processing apparatus 300 are stored to, for example, the first storage apparatus 303 in a restorable state. The processor 301 controlled by the backup software 302 performs backing up in accordance with, for example, a schedule that is set by an administrator of the information processing apparatus 300. The schedule may be set so that backing up is performed with a regular interval of time. In the following description, an operation of the processor 301 that executes the backup software 302 and operates under control of the backup software 302 will be explained as an operation performed by the backup software 302. Data that is backed up is referred to as “backup data”. A storage apparatus storing the data that is backed up is referred to as a “backup destination storage apparatus”.

The backup software 302 is configured to perform backing up, in accordance with an instruction given by, for example, an apparatus that is set in advance, to a storage apparatus designated by the instruction. The apparatus that is set in advance is the control apparatus 100 in the present exemplary embodiment.

There may be a single type of the backup software 302. In this case, the analysis unit 102 explained later may not determine the type of the backup software 302 executed by the information processing apparatus 300. There may be a plurality of types of backup software 302. In this case, as explained later, the analysis unit 102 identifies the type of the backup software 302 executed by the information processing apparatus 300. In the following explanation, there is a plurality of types of backup software 302.

Further, for example, the backup software 302 is configured to integrate backup data stored in a storage apparatus with backup data stored in another storage apparatus in accordance with an instruction given by an apparatus that is set in advance. In the following explanation, integrating backup data with other backup data is described also as integration of the backup data into the other backup data.

For example, integration of first backup data into second backup data is, for example, adding backup data that are included in first backup data but are not included in second backup data to the second backup data. For example, in a case where a set of files is stored into a backup destination storage apparatus in a single operation of backing up, the integration of the backup data can be performed by copying of the set of files. In this case, the integration of the first backup data into the second backup data is adding, to the second backup data, a set of files that are included in the first backup data but are not included in the second backup data.

In the following explanation, in a case where the first backup data are integrated into the second backup data, the first backup data is referred to as “application source backup data” or “integration source backup data”. The storage apparatus storing the first backup data is referred to as an “application source storage apparatus” or an “integration source storage apparatus”. The second backup data is referred to as “application destination backup data” or “integration destination backup data”. The storage apparatus storing the second backup data is referred to as an “application destination storage apparatus” or an “integration destination storage apparatus”. Integrating backup data stored in a given storage apparatus (for example, a storage apparatus A) into backup data stored in another storage apparatus (for example, a storage apparatus B) is also referred to as “integration of backup data from the storage apparatus A to the storage apparatus B”. The “integration of backup data from the storage apparatus A to the storage apparatus B” is also referred to as the “application of backup data from the storage apparatus A to the storage apparatus B”.

For example, the backup software 302 may also be configured to perform backing up by executing a command to perform backing up (which may be hereinafter also referred to as a backup command). In this backup command, for example, data which are to be backed up and the backup destination storage apparatus may be designated. The backup software 302 may be configured to execute processing in accordance with a backup command upon reception of the backup command. In the backup command, the backup destination storage apparatus may be designated by an identifier of the backup destination storage apparatus (which may be hereinafter also referred to as a backup destination identifier).

Similarly, for example, the backup software 302 may perform integration of two backup data by executing a command to perform integration. In the following explanation, a command to perform integration is also referred to as an “integration command”. In the integration command, an integration source storage apparatus and an integration destination storage apparatus are designated. More specifically, in the integration command, for example, the identifier of the integration source storage apparatus and the identifier of the integration destination storage apparatus may be designated by the integration source storage apparatus and the integration destination storage apparatus.

The backup software 302 is configured to transmit a notification including information about the performed backing up to an apparatus that is set as a transmission destination of the notification. In the present exemplary embodiment, the apparatus that is set as the transmission destination of the notification is the control apparatus 100. The notification is transmitted via, for example, email. The notification may also be transmitted via SNMP (Simple Network Management Protocol) trap. The format of the notification may be defined in advance. A format employed as the format of the notification may be different depending on types of the backup software 302. The notification may include information identifying the type of the backup software 302.

The notification may include, for example, an identifier of a backup destination storage apparatus, a data value indicating whether backing up is completed successfully or not, a type of error in a case where the backing up fails, and the like. A type of error in a case where the backing up fails is, for example, a time-out of writing backup data, a rejection of writing backup data by the backup destination storage apparatus, a failure of recognition of the backup destination storage apparatus, or the like. The notification may include a type of error in a case where the backing up is successfully completed. The type of error in a case where the backing up is successfully completed is, for example, an occurrence of retry of writing backup data, a delay of writing backup data, or the like. The type of error is not limited to the above. The type of error may not be the above. An error code may be used for representing the data value indicating whether the backing up is successfully completed or not, the type of error in a case where the backing up fails, and the like. For example, the type of error may be represented by an error code in a plurality of error codes which are different depending on the types of errors.

The control apparatus 100 includes a monitor unit 101, an analysis unit 102, an execution unit 103, an information storage unit 104, and a registration unit 105.

The monitor unit 101 performs monitoring failing in backing up to a first storage apparatus 303. The monitor unit 101 may perform monitoring the failing in the backing up to the first storage apparatus 303 on the basis of a notification from the information processing apparatus 300 that performs the backing up to the first storage apparatus 303. The monitor unit 101 may receive the notification including information about backing up that is performed from the information processing apparatus 300. The notification includes information (for example, the above type of error) indicating an error in the performed backing up that is performed. The notification may include information indicating whether the performed backing up is completed successfully or not. As described above, an error code may be used for representing the type of error in the backing up and the information indicating the backing up is completed successfully or not.

The information storage unit 104 stores a pattern which is included in the notification and by which the type of error is able to be identified for each of the types of error (for example, the above error codes). The information storage unit 104 may further store an operation identifier for each of the types of error. The operation identifier, which the information storage unit 104 stores for a type of error, indicates an operation performed by the control apparatus 100 when the error of the type is detected. The information storage unit 104 may further store, for each of the types of error, an identifier of a backup destination storage apparatus correlated with a type of error.

When an error is detected, the backup destination storage apparatus the identifier of which is correlated with the type of the detected error is selected as a substitution backup destination storage apparatus by the execution unit 103 which is described in detail later. The information storage unit 104 may store a value (hereinafter referred to as an error cause type) indicating whether or not an error of a type is caused by failure of a backup destination storage apparatus for each of the types of error (for example, for each of the error codes). The value of the error cause type may be set to a value indicating that an error is caused by failure of a backup destination storage apparatus or a value indicating that an error is not caused by failure of the backup destination storage apparatus. The error cause type may be represented by other values.

The information storage unit 104 stores, for each of the types of error, a combination of an error code indicating a type of error and an error cause type correlated with the error code in a form of, for example, a table. In the following explanation, a table including a combination of an error code and an error cause type for each of the types of error will be referred to as an “information table”. In a case where error codes are different depending on the type of the backup software 302, the information storage unit 104 may store an information table for each of the types of the backup software 302.

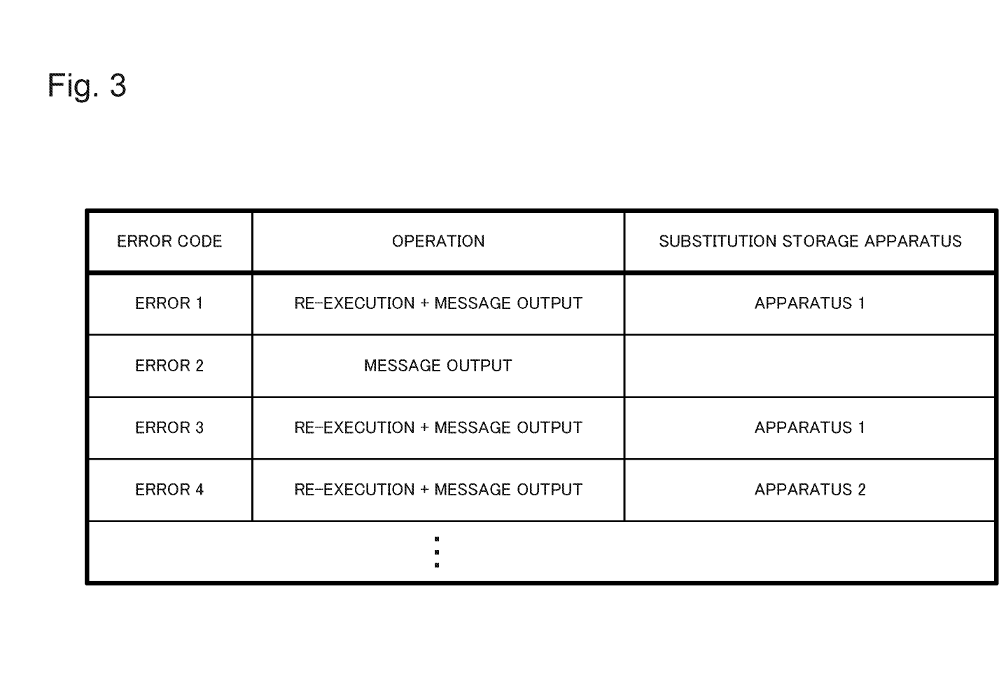

FIG. 3 is a figure schematically illustrating an example of an information table. In the example of FIG. 3, the information table includes a combination of an error code, an operation identifier, and an identifier of a substitution storage apparatus, which are associated with one another, for each of the types of error. The operation identifier indicates an operation performed by the control apparatus 100 when an error identified by the error code correlated with the operation is detected. In the example of FIG. 3, when an error identified by an error code “error 1” is detected, the control apparatus 100 performs “re-execution” and “message output”. The “re-execution” represents transmission of an instruction to perform backing up to the information processing apparatus 300. The “message output” represents an output of a message of a kind set in advance, for example, details of an error, a message indicating an error code, or the like, to the information processing apparatus 300. The “substitution storage apparatus” in FIG. 3 represents an identifier of a backup destination storage apparatus in backing up instructed by an instruction which is transmitted to the information processing apparatus 300 when an error identified by the “error code” occurs. In the present exemplary embodiment, an identifier of one of the second storage apparatuses 200 is stored in the information table as an identifier of the “substitution storage apparatuses”.

The information table illustrated in FIG. 3 is set so that “re-execution” is included in the value of the “operation” with regard to the error code representing an error caused by failure of a backup destination storage apparatus. In contrast, the information table is set so that “re-execution” is not included in the value of the “operation” with regard to an error code representing an error not caused by failure of the backup destination storage apparatus. That is, the value of the “operation” indicates whether an error is caused by failure of a backup destination storage apparatus. In other words, in the example of the information table illustrated in FIG. 3, the “operation” is an error cause type.

In the example of FIG. 3, when an error whose error code is, for example, “error 1” is detected, the control apparatus 100 transmits, to the information processing apparatus 300, an instruction to perform backing up to the storage apparatus whose identifier is “apparatus 1”. Then, the control apparatus 100 transmits a message of a type set in advance to the information processing apparatus 300. As described later, the execution unit 103 of the control apparatus 100 performs transmission of an instruction and output of a message to the information processing apparatus 300.

It should be noted that the information storage unit 104 may not necessarily store error codes of errors of all the types that may be included in notifications. There may be an error whose error code is not stored in the information storage unit 104.

In a case where the format of the notification is different depending on the type of the backup software 302, the information storage unit 104 may further store, individually for the types of the backup software 302, a feature of a notification. The feature of a notification is hereinafter referred to as a notification feature. The notification feature may be, for example, data identifying a structure of data of a notification. As described above, the notification may include data indicating a type of the backup software 302. In this case, the notification feature may be data indicating the type of the backup software 302. The data indicating the backup software is hereinafter referred to as type identifier. The notification feature may be a combination of a type identifier and a position of the type identifier in the notification. The position of the type identifier in the notification is hereinafter referred to as a type identifier storage position.

The registration unit 105 receives the above information table from the terminal apparatus 400, and stores the received information table in the information storage unit 104. The information table is input by, for example, a user of the terminal apparatus 400. Similarly, the registration unit 105 receives the notification feature described above from the terminal apparatus 400, and stores the received notification feature in the information storage unit 104. The notification feature is input by, for example, the user of the terminal apparatus 400.

The analysis unit 102 detects an error in backing up on the basis of the received notification. Then, the analysis unit 102 determines whether or not the detected error is caused by failure of a backup destination storage apparatus of the backing up performed by the information processing apparatus 300, which is the first storage apparatus 303 in the present exemplary embodiment.

The analysis unit 102 identifies the type of error by, for example, detecting, in the received notification, an error code stored in the information storage unit 104. The analysis unit 102 determines whether or not the error is caused by failure of the backup destination storage apparatus on the basis of an error cause type of the error of the type indicated by the detected error code, which is stored by the information storage unit 104.

Under an environment where a format of a notification is different depending on the backup software 302, the analysis unit 102 identifies the backup software 302 executed by the information processing apparatus 300 first. Then, the analysis unit 102 detects an error code for the backup software 302 of the identified type. The analysis unit 102 determines whether or not the error is caused by failure of the backup destination storage apparatus on the basis of an error cause type of the error of the type indicated by the detected error code for the backup software 302 of the identified type.

In this case, the analysis unit 102 may identify the type of the backup software 302 executed by the information processing apparatus 300 by, for example, performing matching the received notification and the notification feature stored individually for the types of the backup software 302 in the information storage unit 104. At this occasion, for example, the analysis unit 102 extracts a notification feature that is consistent with the feature of the received notification. Then, the analysis unit 102 considers that the information processing apparatus 300 executes the backup software 302 of the type whose notification feature is extracted as the notification feature consistent with the feature of the received notification.

In a case where the notification feature includes a type identifier indicating the type of the backup software 302 described above, the analysis unit 102 may detect, in the received notification, the type identifier stored in the information storage unit 104. The analysis unit 102 may consider that the information processing apparatus 300 executes the backup software 302 of the type whose type identifier is detected in the received notification. In a case where the notification feature further includes the type identifier storage position described above, the analysis unit 102 performs matching the data which are read from the type identifier storage position of the notification and the type identifier stored in the information storage unit 104. The analysis unit 102 considers that the backup software 302 executed by the information processing apparatus 300 is the backup software 302 of the type indicated by the type identifier that is the same as the data which are read from the type identifier storage position of the notification.

The analysis unit 102 further detects restoration of the backup destination storage apparatus for the backing up performed by the information processing apparatus 300 on the basis of the received notification. As described above, the backup destination storage apparatus is the first storage apparatus 303 in the description of the present exemplary embodiment. The restoration of the backup destination storage apparatus represents that an error caused by the failure of the backup destination storage apparatus has been detected and becomes not detected in backing up to the backup destination storage apparatus. When an error caused by the backup destination storage apparatus is detected in backing up to the backup destination storage apparatus, the analysis unit 102 may store, for example, the backup destination storage apparatus as an error storage apparatus. More specifically, the analysis unit 102 may store the identifier of the backup destination storage apparatus as an identifier of the error storage apparatus. When the analysis unit 102 receives a notification indicating that backing up to the backup destination storage apparatus stored as the error storage apparatus is successfully completed, the analysis unit 102 may detect restoration of the backup destination storage apparatus. For example, when the analysis unit 102 detects an error code indicating that backing up is completed successfully and an identifier of an backup destination storage apparatus in a notification, the analysis unit 102 considers that the backing up to the backup destination storage apparatus is completed successfully.

When the analysis unit 102 detects an error, the execution unit 103 determines an operation to execute on the basis of the information table stored in the information storage unit 104 and the type of error which is detected. Then, the execution unit 103 executes the determined operation. More specifically, the execution unit 103 executes an operation correlated, in the information table, with the error code of the error which is detected. When the operation includes instructing the information processing apparatus 300 to perform backing up (in the example of FIG. 3, “re-execution”), the execution unit 103 transmits, to the information processing apparatus 300, an instruction to perform backing up to the second storage apparatus 200. In the example of FIG. 3, each of the operations including “re-execution” is the operation including instructing the information processing apparatus 300 to perform backing up. This second storage apparatus 200 instructed to perform backing up is, for example, the second storage apparatus 200 whose identifier is included in the “substitution storage apparatus” in the example of the information table described above. When the operation includes transmitting a message to the information processing apparatus 300, the execution unit 103 outputs a message of a type defined in advance to the information processing apparatus 300. In the example illustrated in FIG. 3, each of the operations including “message output” is the operation including transmitting a message to the information processing apparatus 300.

When no error is detected (i.e., in a case where none of the error codes stored in the information storage unit 104 is detected) in the notification received by the monitor unit 101, the execution unit 103 may perform nothing. When no error is detected in the notification received by the monitor unit 101, the execution unit 103 may perform an operation defined in advance (for example, a transmission of a message showing details of a notification to the information processing apparatus 300).

As described above, the information table illustrated in FIG. 3 is configured so that “re-execution” is included in an operation correlated with an error code of an error detected in backing up and caused by failure of a backup destination storage apparatus. The information table illustrated in FIG. 3 is configured so that “re-execution” is not included in an operation correlated with an error code of an error detected in backing up and caused by failure of a backup destination storage apparatus. In a case where such an information table is used, identifying an error code corresponds to determining whether or not an error in backing up is caused by failure of a backup destination storage apparatus.

In the following description, the execution unit 103 is explained in more details.

When an error in backing up is determined to be caused by failure of the backup destination storage apparatus, the execution unit 103 transmits, to the information processing apparatus 300, an instruction to perform backing up using the second storage apparatus 200 as the backup destination storage apparatus. On this occasion, the execution unit 103 may generate a backup command to perform backing up to the second storage apparatus 200. Then, the execution unit 103 may transmit the generated backup command to the information processing apparatus 300.

When the analysis unit 102 detects restoration of the first storage apparatus 303, the execution unit 103 transmits, to the information processing apparatus 300, an instruction to integrate the backup data stored in the second storage apparatus 200 with the backup data stored in the first storage apparatus 303. On this occasion, the execution unit 103 may generate an integration command to integrate the backup data stored in the second storage apparatus 200 with the backup data stored in the first storage apparatus 303. Then, the execution unit 103 may transmit the generated integration command to the information processing apparatus 300.

In a situation in which a command that can be executed by the backup software 302 is different depending on the type of the backup software 302, the analysis unit 102 identifies the type of the backup software 302 executed by the information processing apparatus 300. Then, the execution unit 103 generates a command for the backup software 302 (for example, the backup command and the integration command described above). The command for the backup software 302 is a command that can be executed by the backup software 302 of the type identified by the analysis unit 102.

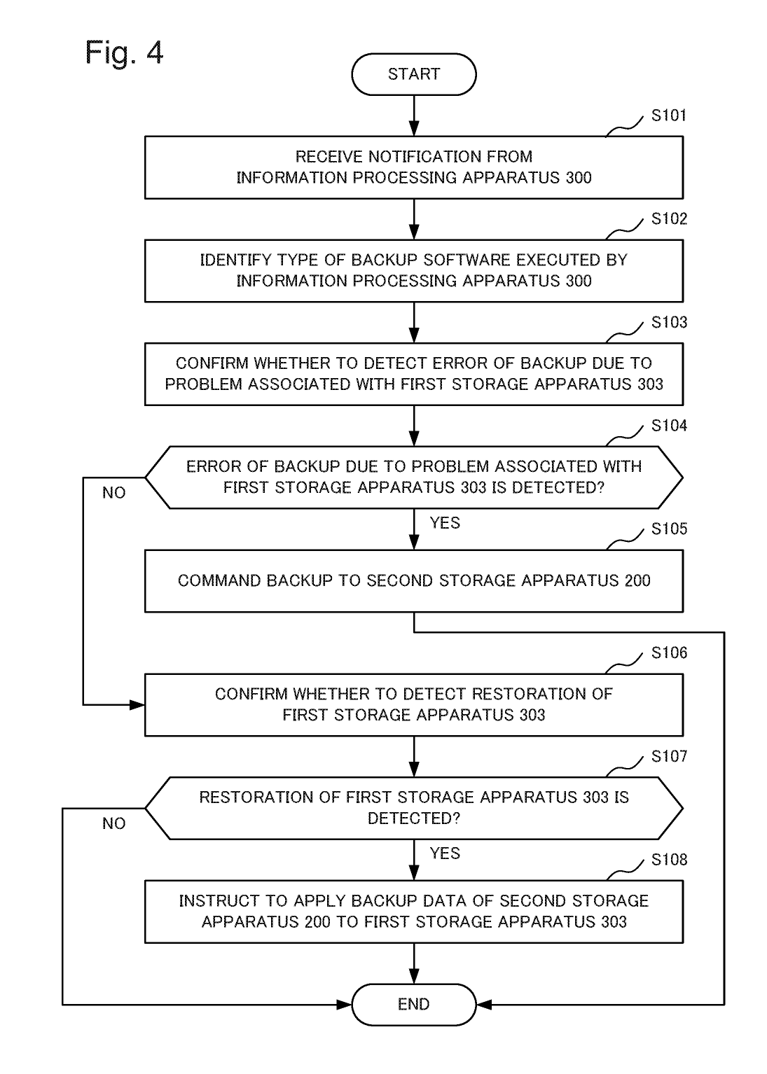

Next, the operation of the control system 1 according to the present exemplary embodiment will be explained in detail with reference to drawings. FIG. 4 is a flow chart illustrating an example of an operation of the control system 1 according to the present exemplary embodiment. FIG. 4 illustrates an operation when the control system 1 receives a notification from the information processing apparatus 300.

First, the monitor unit 101 receives a notification from the information processing apparatus 300 (Step S101). As described above, the notification is a mail, an SNMP trap, or the like transmitted by the processor 301 executing the backup software 302.

The analysis unit 102 identifies the type of the backup software 302 executed by the information processing apparatus 300 on the basis of the received notification (Step S102). The analysis unit 102 confirms whether to detect an error (i.e. failing) in backing up caused by failure of the first storage apparatus 303 on the basis of the received notification (step S103).

The analysis unit 102 detects an error in backing up by, for example, detecting an error code in the notification. When an error code is detected in the notification, the analysis unit 102 determines that there is an error in the backing up. In a case where any error code is not detected in the notification, the analysis unit 102 determines that there is not an error in the backing up. Then, the analysis unit 102 determines whether or not the detected error code indicates an error caused by failure of the backup destination storage apparatus. For example, in a case where the detected error code is correlated with a value indicating that the error is caused by failure of the backup destination storage apparatus in the information storage unit 104, the analysis unit 102 determines that the detected error code indicates an error caused by the failure of the first storage apparatus 303. For example, a case where the detected error code is not correlated with a value indicating that the error is caused by failure of the backup destination storage apparatus in the information storage unit 104, the analysis unit 102 determines that the detected error code does not indicate an error caused by failure of the first storage apparatus 303. In a case where an error code is detected in the notification, and further, the error code indicates an error caused by failure of the first storage apparatus 303, the analysis unit 102 may detect an error caused by the problem of the first storage apparatus 303 in backing up. Otherwise, the analysis unit 102 does not detect an error caused by failure of the first storage apparatus 303 in backing up.

In a case where the information table illustrated in FIG. 3 is stored in the information storage unit 104, the analysis unit 102 determines whether or not “re-execution” is included in the value of the “operation” correlated with the detected error code. In a case where “re-execution” is included in the value of the “operation” correlated with the detected error code, the analysis unit 102 may detect an error caused by failure of the first storage apparatus 303 in backing up. In a case where “re-execution” is included in the value of the “operation” correlated with the detected error code, the analysis unit 102 does not detect an error caused by failure of the first storage apparatus 303 in backing up.

In a case where failing caused by failure of the first storage apparatus 303 is detected in backing up (YES in Step S104), the execution unit 103 instructs the information processing apparatus 300 to perform backing up to the second storage apparatus 200 (Step S105). Upon receiving the instruction, the information processing apparatus 300 executes backing up to the second storage apparatus 200 in accordance with the instruction.

For example, in the information table illustrated in FIG. 3, the execution unit 103 selects, as a substitution backup destination storage apparatus, the second storage apparatus 200 identified by the value of the “substitution storage apparatus” correlated with the detected error code. The substitution backup destination storage apparatus is an storage apparatus to which backing up is performed when an error occurs in backing up to the first storage apparatus 303. Then, the execution unit 103 generates a backup command to perform backing up to the second storage apparatus 200 which is selected. The backup command generated by the execution unit 103 is a command depending on the type of the backup software 302 identified.

The execution unit 103 correlates the identifier of the selected second storage apparatus 200 and the identifier of the information processing apparatus 300 which is the transmission destination of the backup command, and stores the identifier of the selected second storage apparatus 200 and the identifier of the information processing apparatus 300 which are correlated with each other in, for example, the information storage unit 104. In the following explanation, “substitution information” indicates a combination of the identifier of the information processing apparatus 300 which is the transmission destination of the backup command and the identifier of the second storage apparatus 200 the identifier of which correlated with the identifier of the information processing apparatus 300 and which is selected as a substitution backup destination storage apparatus.

Then, the execution unit 103 transmits the generated backup command to the information processing apparatus 300. The information processing apparatus 300, upon receiving the backup command, performs the backup to the second storage apparatus 200 by executing the backup command.

In a case where failing in backing up caused by failure of the first storage apparatus 303 is not detected (NO in Step S104), the analysis unit 102 confirms whether to detect restoration of the first storage apparatus 303 (Step S106).

In a case where the restoration of the first storage apparatus 303 is detected (YES in Step S107), the execution unit 103 instructs the information processing apparatus 300 to apply the backup data of the second storage apparatus 200 to the first storage apparatus 303 (Step S108). When the information processing apparatus 300 is instructed to apply the backup data, the information processing apparatus 300 applies the backup from the second storage apparatus 200 to the first storage apparatus 303.

For example, the execution unit 103 reads out, from the information storage unit 104, the above-described substitution information of the information processing apparatus 300 having the first storage apparatus 303 whose restoration is detected. Then, the execution unit 103 identifies, in the substitution information which is read out, the second storage apparatus 200 selected as the substitution backup destination storage apparatus for the information processing apparatus 300. The execution unit 103 generates a command to apply the backup data stored in the identified second storage apparatus 200 to the backup data stored in the first storage apparatus 303. Then, the execution unit 103 transmits the generated command to the information processing apparatus 300. When receiving the command, the information processing apparatus 300 executes the command to apply the backup data in the second storage apparatus 200 to the backup data in the first storage apparatus 303.

In a case where the information storage unit 104 stores the information table illustrated in FIG. 3, and the value of the “operation” correlated with the detected error code includes a “message output”, the execution unit 103 further transmits a message to the information processing apparatus 300. The transmitted message is, for example, a message including the error code. Next, an operation of registering the information table by the control system 1 according to the present exemplary embodiment will be explained in detail with reference to drawings.

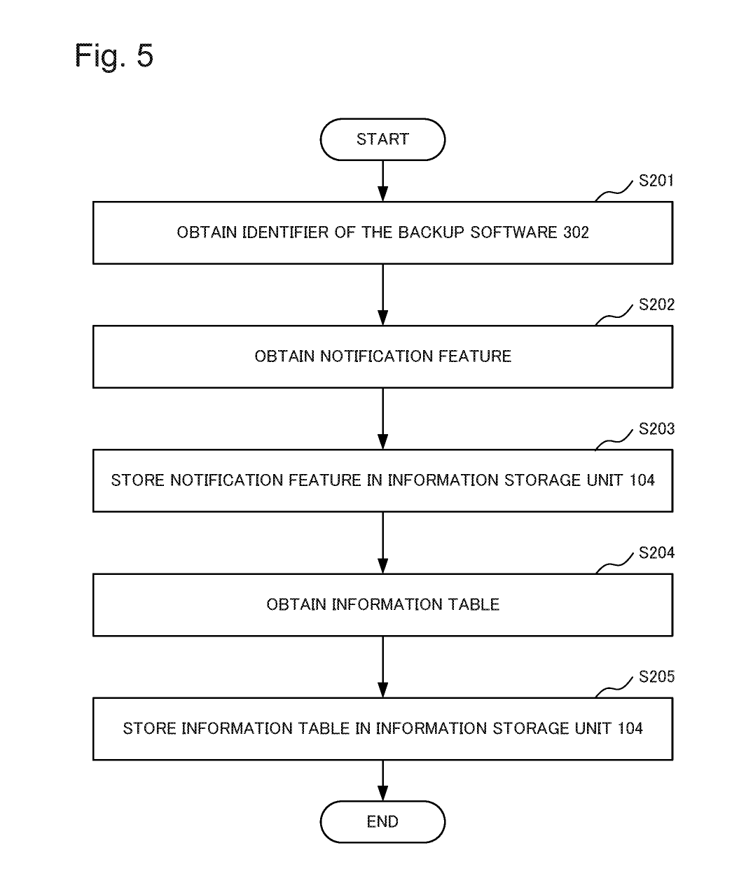

FIG. 5 is a flow chart illustrating an example of an operation of registering the information table by the control system 1 according to the present exemplary embodiment. The flow chart shown in FIG. 5 illustrates an operation of the control system 1 in a case where an administrator of the control system 1, by using the terminal apparatus 400, newly registers an information table for a type of backup software 302 and the like to the control system 1.

According to FIG. 5, first, the registration unit 105 obtains, from the terminal apparatus 400, an identifier of the backup software 302 for which the information table and the like are registered (Step S201). Next, the registration unit 105 obtains, from the terminal apparatus 400, a notification feature which is a feature of a notification transmitted by the backup software 302 (Step S202). The registration unit 105 correlates the notification feature that is obtained with the identifier of the backup software 302 obtained in Step S201. Then, the registration unit 105 stores, in the information storage unit 104, the notification feature correlated with the identifier of the backup software 302 obtained in Step S201 (Step S203). The registration unit 105 further obtains the information table from the terminal apparatus 400 (Step S204). The registration unit 105 correlates the obtained information table with the identifier of the backup software 302 obtained in Step S201. Then, the registration unit 105 stores the information table correlated with the identifier of the backup software 302 obtained in Step S201 in the information storage unit 104 (Step S205).

The present exemplary embodiment explained above has an effect that it is possible to avoid failing in backing up while reducing a cost.

This is because the analysis unit 102 detects an error caused by failure of the first storage apparatus 303 in backing up. The analysis unit 102 detects the error in the notification from the information processing apparatus 300. The notification is received by the monitor unit 101. Then, when detecting the error caused by failure of the first storage apparatus 303 in backing up, the execution unit 103 instructs the information processing apparatus 300 to perform backing up to a second storage apparatus 200. Therefore, data which is to be backed up to the first storage apparatus 303 but is not backed up because of the error in backing up is backed up to the second storage apparatus 200. In other words, it is possible to avoid failing in backing up. In the present exemplary embodiment, a plurality of systems of communication paths and resources are not required. Therefore, it is possible to reduce the cost. The backup software 302 executed by the processor 301 of the information processing apparatus 300 does not need to be dedicatedly implemented software. Therefore, it is possible to further reduce the cost.

### Second Exemplary Embodiment

Next, a second exemplary embodiment of the present invention will be explained in detail with reference to drawings.

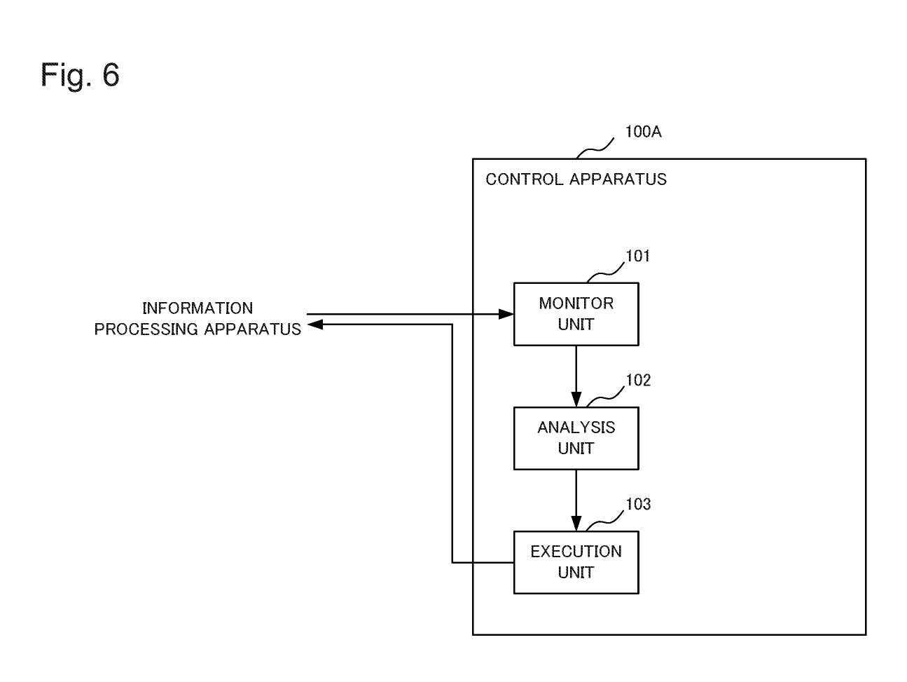

FIG. 6 is a block diagram illustrating an example of a configuration of a control apparatus 100A according to the second exemplary embodiment of the present invention.

As shown in FIG. 6, the control apparatus 100A according to the present exemplary embodiment includes the monitor unit 101, the analysis unit 102, and the execution unit 103. The monitor unit 101 receives, from the information processing apparatus 300 performing backing up to the first storage apparatus 303, a notification including information about an error in the backing up. The analysis unit 102 detects an error in backing up on the basis of the notification, and performs a failure analysis to identify whether or not the error is caused by failure of the first storage apparatus 303. In a case where the error is caused by failure of the first storage apparatus 303, the execution unit 103 transmits, to the information processing apparatus 300, an identifier of a second storage apparatus 200 with which the information processing apparatus 300 is capable of communicating as a backup destination identifier. The information processing apparatus 300 performs, upon reception of the backup destination identifier, backing up to the storage apparatus identified by the backup destination identifier.

Next, an operation of the control apparatus 100A according to the present exemplary embodiment of the present invention is described with reference to drawings.

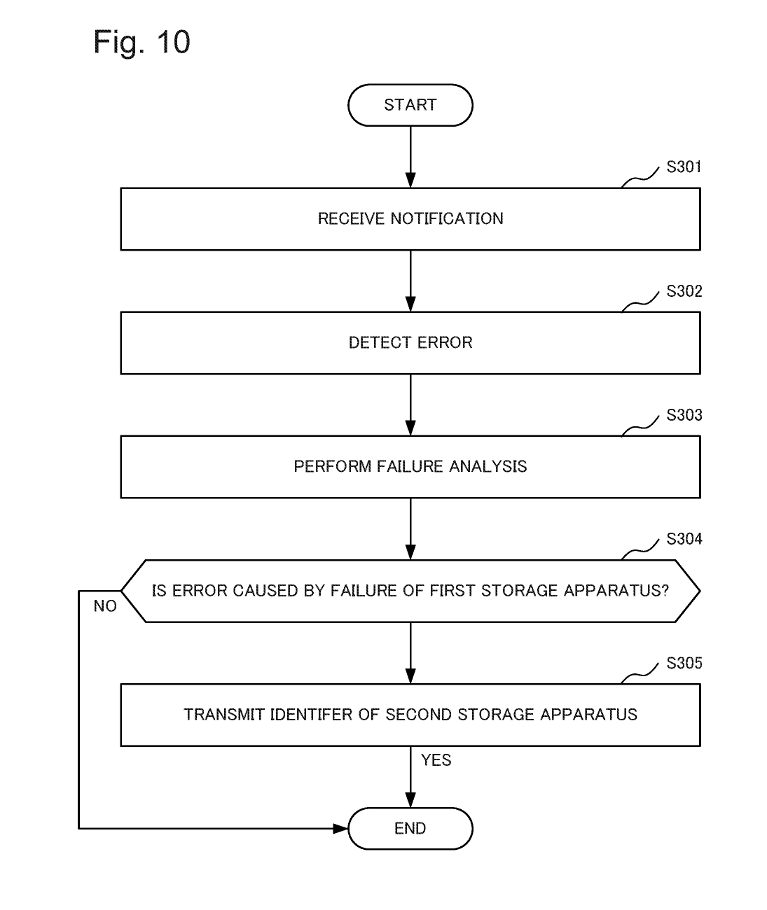

FIG. 10 is a flow chart illustrating an example of the operation of the control apparatus 100A according to the present exemplary embodiment of the present invention.

In the operation illustrated in FIG. 10, the monitor unit 101 receives, from the information processing apparatus 300 performing backing up to the first storage apparatus 303, a notification including information about an error in the backing up (Step S301). The analysis unit 102 detects an error in backing up on the basis of the notification (Step S302), and performs a failure analysis to identify whether or not the error is caused by failure of the first storage apparatus 303 (Step S303). When the error is not caused by failure of the first storage apparatus (NO in Step S304), the operation illustrated in FIG. 10 ends. When the error is caused by failure of the first storage apparatus (YES in Step S304), the execution unit 103 transmits, to the information processing apparatus 300, the an identifier of the a second storage apparatus 200 with which the information processing apparatus 300 can communicate is capable of communicating as the a backup destination identifier of the backup destination (Step S305). Then the operation illustrated in FIG. 10 ends.

The present exemplary embodiment described above has the same effect as that of the first exemplary embodiment. The reason for the effect is the same as the reason why the effect of the first exemplary embodiment arises.

### Other Exemplary Embodiments

Each of the control apparatuses 100 and 100A according to the exemplary embodiments described above can be implemented with circuitry. The circuitry is, for example, one or more computers each of which includes at least a processor and a memory and communicably connected with one another. The circuitry may be one or more dedicated circuits communicably connected with one another. The circuitry may be a combination of one or more computers and one or more dedicated circuits communicably connected with one another. Each of the control apparatuses 100 and 100A may be implemented as a single apparatus. Each of the control apparatuses 100 and 100A may be implemented as a plurality of apparatuses communicably connected with one another.

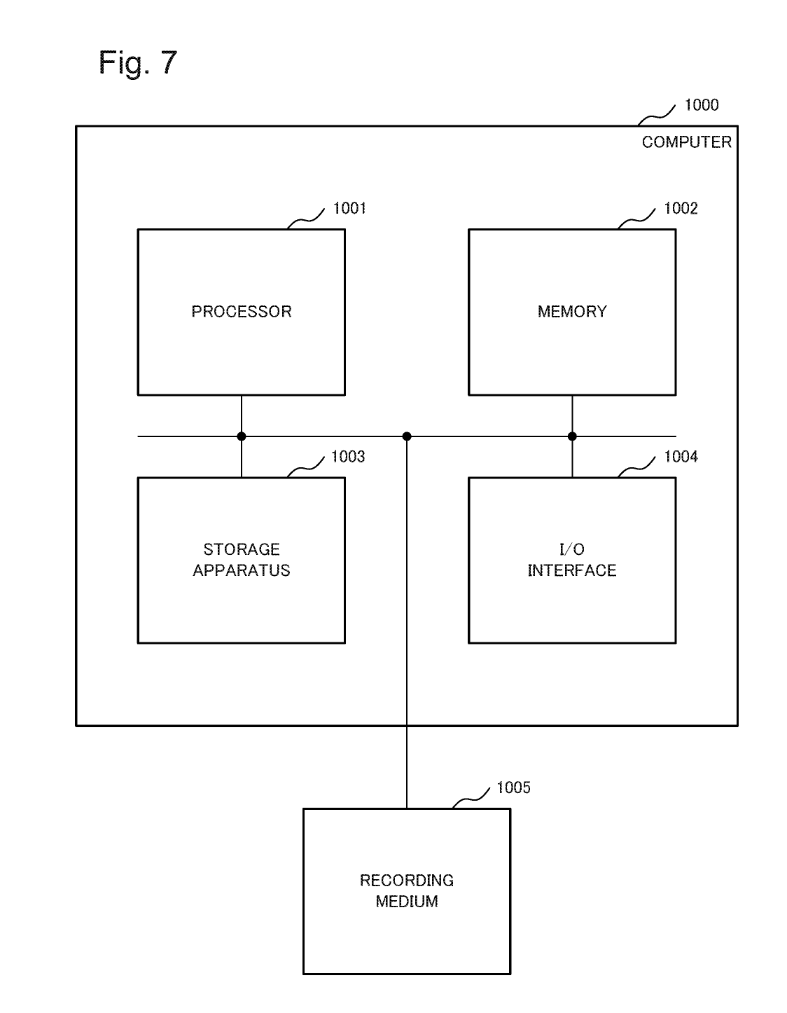

FIG. 7 is a figure illustrating an example of a hardware configuration of a computer 1000 with which the control apparatus 100 and the control apparatus 100A according to the exemplary embodiments described above can be implemented. In FIG. 7, the computer 1000 includes a processor 1001, a memory 1002, a storage apparatus 1003, and an I/O (Input/Output) interface 1004. The computer 1000 can access the recording medium 1005. Each of the memory 1002 and the storage apparatus 1003 is a storage apparatus such as, a RAM (Random Access Memory), or a hard disk. The recording medium 1005 is, for example, a storage apparatus such as a RAM or a hard disk, a ROM (Read Only Memory), or a portable recording medium. The storage apparatus 1003 may operate the recording medium 1005. The processor 1001 can read data and a program from the memory 1002 and the storage apparatus 1003 and can write data and a program to the memory 1002 and the storage apparatus 1003. The processor 1001 can access, for example, the information processing apparatus 300 and the terminal apparatus 400 through the I/O interface 1004. The processor 1001 can access the recording medium 1005. The recording medium 1005 stores a program causing the computer 1000 to operate as the control apparatus 100 or the control apparatus 100A.

The processor 1001 loads, into the memory 1002, the program causing the computer 1000 to operate as the control apparatus 100 or the control apparatus 100A from the recording medium 1005 storing the program. Then, the processor 1001 executes the program loaded into the memory 1002, so that the computer 1000 operates as the control apparatus 100 or the control apparatus 100A.

Each of the units in the first group described below is implemented with, for example, the memory 1002 storing a dedicated program having a function of each of the unit, and the processor 1001 executing the dedicated program stored in the memory 1002. The dedicated program may be stored in the recording medium 1005 and may loaded into the memory 1002 from the recording medium. The first group includes the monitor unit 101, the analysis unit 102, the execution unit 103, and the registration unit 105. Each of the units in the second group described below can be implemented with the memory 1002 or the storage apparatus 1003 such as a hard disk device, which are included in the computer 1000. The second group includes the information storage unit 104. Alternatively, at least one of the units included in the first group and the units included in the second group can be implemented with dedicated circuits having the functions of the units.

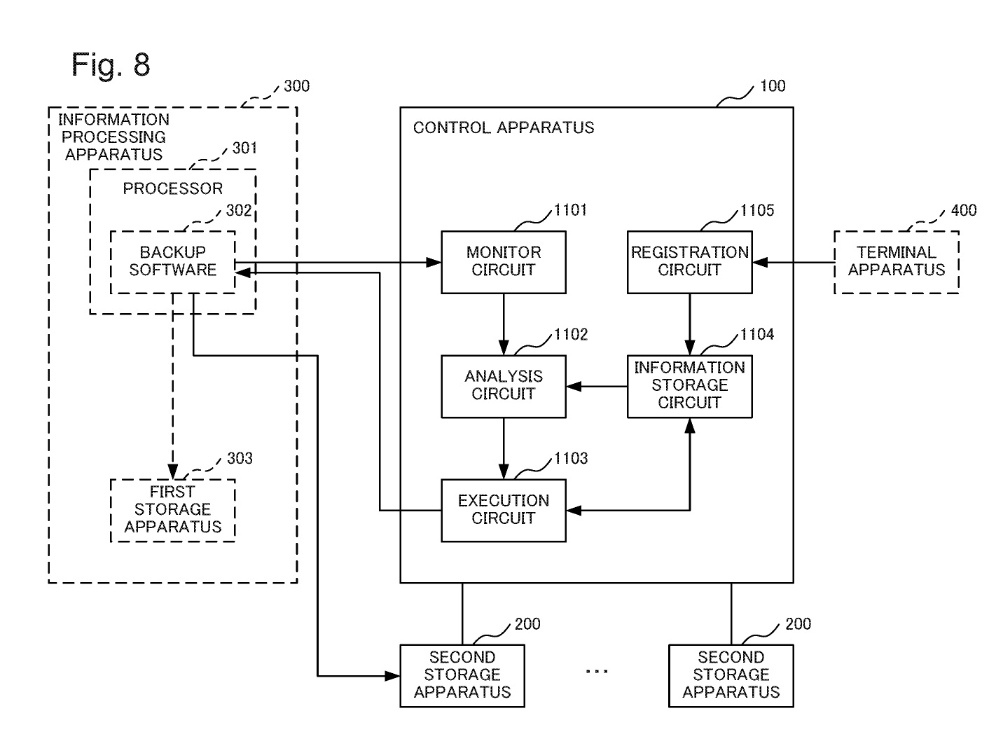

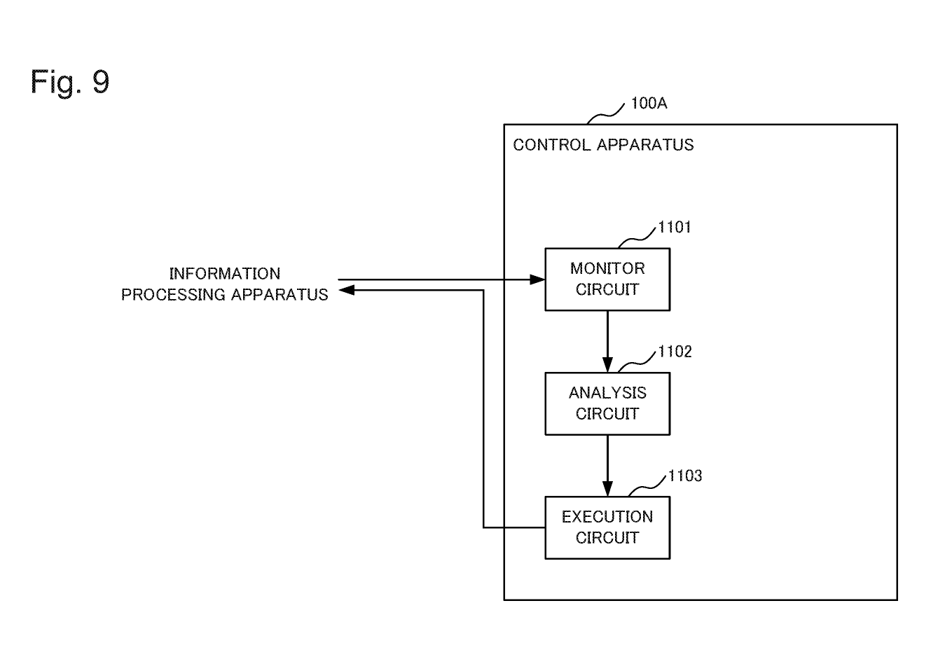

FIG. 8 is a block diagram illustrating an example of a configuration of the control apparatus 100, implemented with a dedicated circuit, according to the first exemplary embodiment of the present invention. FIG. 9 is a block diagram illustrating an example of a configuration of the control apparatus 100A, implemented with a dedicated circuit, according to the second exemplary embodiment of the present invention. In the example of FIG. 8, the control apparatus 100 includes a monitor circuit 1101, an analysis circuit 1102, an execution circuit 1103, an information storage circuit 1104, and a registration circuit 1105. In the example of FIG. 9, the control apparatus 100A includes a monitor circuit 1101, an analysis circuit 1102, and an execution circuit 1103.

In these drawings, the monitor circuit 1101 operates as the monitor unit 101. The analysis circuit 1102 operates as the analysis unit 102. The execution circuit 1103 operates as the execution unit 103. The information storage circuit 1104 operates as the information storage unit 104. The registration circuit 1105 operates as the registration unit 105.

In the technology described in PTL 1, backing up cannot be performed unless a plurality of systems of resources and paths required for backing up data are ensured. In other words, a high cost is required to perform the backup.

The present invention has the effect that it is possible to avoid failing in a backing up while reducing the cost.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A control apparatus comprising:
circuitry configured to:
receive a notification including information about an error in backing up to a first storage apparatus;
perform failure analysis to detect an error in the backing up on a basis of the notification, and determine whether or not the error is caused by failure of the first storage apparatus; and
instruct, when the error is caused by the failure of the first storage apparatus, an information processing apparatus performing the backing up to perform backing up to a second storage apparatus capable of communicating with the information processing apparatus to the second storage apparatus.

2. The control apparatus according to claim 1, wherein
the circuitry is further configured to:
detect restoration of the first storage apparatus on a basis of the notification; and
instruct, when the restoration of the first storage apparatus is detected, the information processing apparatus to store, in the first storage apparatus, backup data stored in the second storage apparatus by the backing up.

3. The control apparatus according to claim 1, wherein
the circuitry is further configured to:
store notification features each of which is a feature of the notification, and patterns, in the notification, each of which indicates occurrence of an error due to failure of the first storage apparatus in the backing up, individually for types of the backup software controlling the information processing apparatus to perform the backing up, transmission of the notification, and reception of a command and execution of the command;
identify a type of the backup software controlling the information processing apparatus by performing matching the notification with the notification features, and perform the failure analysis by detecting, in the notification, a pattern of the patterns for the identified type of the backup software; and
generate a command for the backup software the type of which is identified to perform backing up to the second storage apparatus, and instruct the information processing apparatus to perform the backing up by transmitting the command to the information processing apparatus.

4. A control system including the control apparatus according to claim 1, comprising:
the second storage apparatus.

5. A control method comprising:
receiving a notification including information about an error in backing up to a first storage apparatus;
performing failure analysis to detect an error in the backing up on a basis of the notification, and determining whether or not the error is caused by failure of the first storage apparatus; and
instructing, when the error is caused by the failure of the first storage apparatus, an information processing apparatus performing the backing up to perform backing up to a second storage apparatus capable of communicating with the information processing apparatus.

6. The control method according to claim 5, further comprising:
detecting restoration of the first storage apparatus on a basis of the notification; and
instructing, when the restoration of the first storage apparatus is detected, the information processing apparatus to store, in the first storage apparatus, backup data stored in the second storage apparatus by the backing up to the second storage apparatus.

7. The control method according to claim 5, further comprising:
storing notification features each of which is a feature of the notification, and patterns, in the notification, each of which indicates occurrence of an error due to failure of the first storage apparatus in the backing up, individually for types of backup software backup software controlling the information processing apparatus to perform the backing up, transmission of the notification, and reception of a command and execution of the command;
identifying a type of the backup software controlling the information processing apparatus by performing matching the notification with the notification features, and performing the failure analysis by detecting, in the notification, a pattern of the patterns for the identified type of the backup software; and
generating a command for the backup software the type of which is identified to perform backing up to the second storage apparatus, and instructing the information processing apparatus to perform the backing up by transmitting the command to the information processing apparatus.

8. A non-transitory computer readable storage medium storing a control program causing a computer to execute processing of:
receiving, from an information processing apparatus performing backing up to a first storage apparatus, a notification including information about an error in the backing up;
performing failure analysis to detect an error in the backing up on a basis of the notification, and determining whether or not the error is caused by failure of the first storage apparatus; and
instructing, when the error is caused by the failure of the first storage apparatus, an information processing apparatus performing the backing up to perform backing up to a second storage apparatus capable of communicating with the information processing apparatus.

9. The non-transitory computer readable storage medium according to claim 8, storing the control program causing a computer to execute processing of:
detecting restoration of the first storage apparatus on a basis of the notification; and
instructing, when the restoration of the first storage apparatus is detected, the information processing apparatus to store, in the first storage apparatus, backup data stored in the second storage apparatus by the backing up.

10. The non-transitory computer readable storage medium according to claim 8, storing the control program causing a computer to execute processing of:
storing notification features each of which is a feature of the notification, patterns, in the notification, each of which indicates occurrence of an error due to a failure of the first storage apparatus in the backing up, individually for types of the backup software controlling the information processing apparatus to perform the backing up, transmission of the notification, and reception of a command and execution of the command;
identifying a type of the backup software controlling the information processing apparatus by performing matching the notification with the notification features, and performing failure analysis by detecting, in the notification, a pattern of the patterns for the identified type of the backup software; and
generating a command for the backup software the type of which is identified to perform backing up to the second storage apparatus, and instructing the information processing apparatus to perform the backing up by transmitting the command to the information processing apparatus.
